(19) United States
(12) Patent Application Publication
(10) Pub. No.: US 2004/0245225 A1
(43) Pub. Date: Dec. 9, 2004

(54) Making color in two - and three - dimensional images created in glass with laser induced micro-explosions

(76) Inventor: Alexander Kastalsky, Wayside, NJ (US)

Correspondence Address: Alexander Kastalsky, 3 Kenneth Dr., Wayside, NJ, 07712, US

(21) Appl. No.: 10/452,962

(22) Filed: Jun. 4, 2003

(51) Int. Cl. B23K 26/00

(52) U.S. Cl. 219/121.69

(57) ABSTRACT

New method of introducing color to two- and three-dimensional images produced in glass or any other transparent media with laser induced micro-explosions, is proposed. The method is based on utilization of a special color film, which consists of multiple periodically repeating transparent stripes of filters of major Red, Green and Blue (RGB) colors. The color film is attached to the glass in front of the image, while external parallel beam of white light illuminates the image through this color film. The image becomes subdivided into multiple color stripes (for two-dimensional image) or slices (for three-dimensional image), which thus transform the image into RGB color sub-pixels. The computer program places the visible dots, resulting from the micro-explosions, into corresponding sub-pixel areas to reproduce the original colors of the image stored in the computer memory. If the sub-pixel pitch is sufficiently short, the human eye perceives the image as a colored one.

### FIELD OF THE INVENTION

This invention relates to creating of two- and three-dimensional images in glass or any other transparent media, based on computer controlled formation of visible dots through the process of micro-explosions produced by focused pulsed laser beam. More specifically, the invention provides a method for introducing color into 2D and 3D images in the glass made by this technique.

### BACKGROUND OF THE INVENTION

Formation of visible dots in the glass using powerful lasers pulses is a well developed technique for making sculptures and portraits. Visible dots inside the glass are formed due to micro-explosions created by a focused laser beam, see e.g. B. M. Ashkinadze, V. L. Vladimirov, V. A. Likharev, S. M. Ryvkin, V. M. Salmanov and I. D. Jaroshetcki, Breakdown in Transparent Dielectrics Caused by Intense Laser Radiation, Soviet Physics JETP, V. 33, p. 788 1966. The image in the glass is obtained by a computer controlled motion of the laser beam to produce the dots in accordance with the image stored in the computer memory. Two dimensional laser motion is needed for the portraits while three-dimensional one is needed for the sculptures. The resultant dots are intense light scatterers, so the image in the glass exposed to the external light, becomes visible in the scattered light.

The size of the dots depends on the laser energy and pulse duration, varying typically from 20 μm to 100 μm. The size variation allows making gray levels in the image. Another method for producing gray levels relates to a variation of the dot density. The color of a single dot is white, so the gray levels gradation provides variations from white to black (no dots). Realistically, about 10 gray levels, depending on the dot size, can be implemented in the image.

It is obvious, that both number of gray levels and the resolution increase as the dot size is reduced. Smaller dots, 20 μm in diameter, can be obtained with ˜a few ps pulse width of a single mode laser operating at the wavelength of 0.535 μm (green) with the energy in the pulse of ˜1.5 mJ. The frequency of dot production (number of dots per second) depends on the laser power and typically varies from 50 Hz to 1 kHz. Single mode, green laser with short pulses and high power is preferable for a fast, high quality image production.

The main drawback of the images produced this way is absence of colors. The photography stored in the computer contains all the colors of the original. However, in the process of reproducing the image in the glass, the colors are lost. It would be, therefore, extremely appealing to retain in the glass natural colors of an object or a person, which exist in the original digital photography or sculpture stored in the computer memory.

### OBJECTS OF THE INVENTION

It is a general object of the present invention to introduce a new method of making original colors in 2D and 3D images in the glass, or any other transparent media, created with laser induced dots.

### SUMMARY OF THE INVENTION

The proposed method relies on two technology modifications related to:

1. Introducing of an additional transparent film attached to the glass which subdivides the image into multiple three color sub-pixels, and a specific method of illumination of the image in the glass through this film;

2. New software program of the image processing in the glass to provide the dot position in the image in accordance with new coloring technique to reproduce the colors of the original 2D or 3D image.

The additional transparent film (color film) is the main element of the invention. It contains a periodically repeating structure of transparent parallel stripes of filters composing three major colors: Red, Green and Blue (RGB). The color film is attached to the glass side, while the external parallel beam is directed normal to this side, so that the color film is placed between the light source and the image. The choice of this side depends on whether the 2D or 3D image is under the processing. For the two-dimensional images, the color film is attached in front of the image and preferably parallel to the image plane. For the 3D images, any of the glass sides for the color film placement (and illumination through this film) can be used. It is however preferable to place the color film in front of the glass side facing the largest 3D image cross-section. In both cases, the resultant effect is subdivision of the glass volume into multiple slices containing parallel light beams of periodically alternating RGB colors. Therefore, the dots in the image are exposed to three different colors depending on their location within this periodic light structure.

The new software program serves to place the dots in appropriate locations within RGB triads to provide the original colors in the image. If the pitch of this RGB triad is sufficiently short, the human eye perceives the image as a colored one. This effect of coloring is similar to what takes place in any color displays, where each pixel is composed of RGB sub-pixels, and color selection is accomplished through mixing the light intensities from each color sub-pixel.

The gray (color) levels can be implemented through variation of the number and the size of the dots belonging to different color stripes within each RGB triad. Variation of number of the scattering centers and their size vary the total amount of light scattered from each color area in the triad.

Thus, the proposed method converts uncolored (black and white) image in the glass, or any other transparent media, such as plastic, into colored image by illumination of the image with a parallel white light beam through the transparent color film containing multiple color filters to subdivide the image into multiple stripes (or slices for the 3D images) of RGB triads, while the computer program provides corresponding dot distribution within the glass to form a color image in the scattered light.

The previous considerations are related to viewing the image in the scattered light, i.e. under a certain angle to the beam direction. The same technique, however, with appropriate modifications, can be applied to viewing the image in the transmitted light, i.e. in the direction of the light beam. This viewing orientation is convenient for making image projection on a screen. In this case, the light scattered by the dots does not pass through the image in the glass, and the resultant effect is a negative image, like the image normally seen in a photo-film made in the photography process. To convert the negative image into the positive one, and thus view the realistic image in this direction, the dot placement in the image, as well as the dot placement within the RGB triads, must be appropriately inverted.

### BRIEF DESCRIPTION OF THE DRAWINGS

FIG. 1 illustrates the process of coloring of the two-dimensional image.

FIG. 2 schematically shows dot distribution in three image layers.

FIG. 3 illustrates the process of coloring of the three-dimensional image.

### DETAILED DESCRIPTION OF THE DRAWINGS

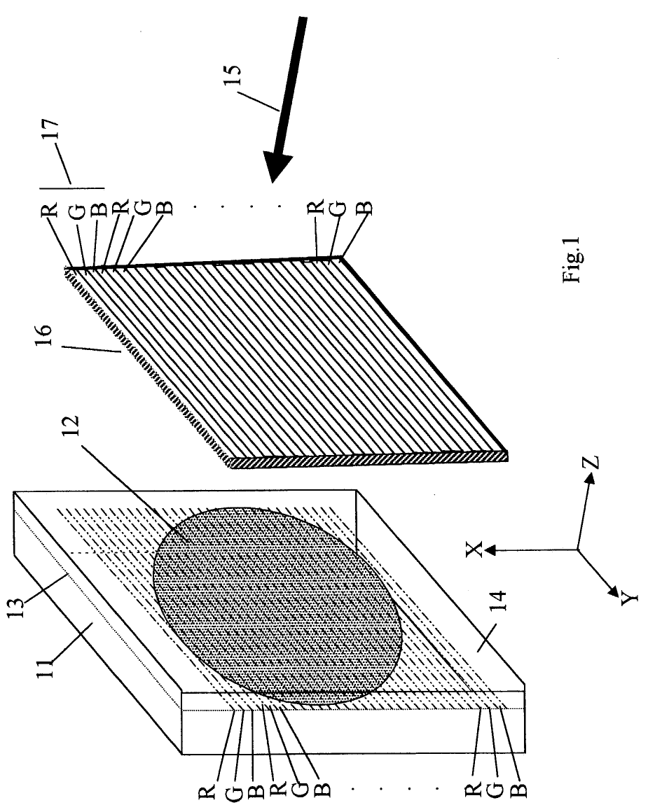

Shown in a 3-dimensional picture of FIG. 1, is a piece of transparent material 11, typically glass, which contains a specially prepared, laser produced image 12 in the plane 13 parallel to the face surface of the glass 14. A parallel beam of light 15 is directed upon the glass normal to the face surface of the glass and through the color film l6 comprised of multiple and periodically repeating transparent RGB filter stripes 17, which are extended along one direction (Y in FIG. 1) and periodically alternated in the film plane along the perpendicular axis (X). The film 16 is attached to the glass surface 14 and aligned in X direction with sub-pixel sections in the image 12, corresponding to particular colors (see below). For the sake of description clarity, the film 16 is shown removed from the glass. The image 12 is thus illuminated with RGB stripes, periodically repeating in X direction.

The dots composing the image 12 are formed, according to the present invention, in such a manner that they fall into the corresponding color sections of RGB triads to reproduce the original colors of the image in the glass, when the color film 16 is appropriately aligned in both X and Y directions with the image 12, and a parallel beam of light illuminates the image. In Y direction, the dots are placed in a regular manner in accordance with the image content. When the RGB period is sufficiently small, the image is perceived as a colored one. If, for example, the full RGB width in X direction is 300 μm, i.e. 100 μm per color, this will provide the color image quality of a modern computer monitor. The color stripes with these dimensions can be produced using a high quality color printer and a transparent paper, thereby simplifying the fabrication process for color film.

To avoid color mixing, the dot size must not exceed the color stripe width, while the distance between the dots belonging to different colors (i.e. along X direction) must match the pitch in the color film (100 μm in the above presented example). Another possible source of the color mixing can arise if the light beam is not parallel. It is desirable to maintain the light beam 15 parallel at least within the distance between the color film 16 and the image plane 13. To minimize the beam spread, it is therefore preferable to make the image plane as close as possible to the surface 14.

The multiple color levels in the image can be introduced by varying either the number of dots belonging to different color stripes or changing the dot size. The latter is controlled by the laser pulse amplitude. As mentioned earlier, the smallest possible dot size is about 20 μm. This implies that, if the color pixel area is chosen to be 100×300 μm (as in the modern computer monitor), one can form 100 levels per each color (10⁶ total) only by varying the number of dots, i.e. without varying the dot size.

The image in the glass is typically made with more than one plane layer of the dots to enhance the artistic impression. Therefore, the procedure of sorting dots out in accordance with their color identity must be repeated in each layer. The dots within different layers of the same color triad must be shifted from each other in the X-Y plane to uniformly expose them to the light. To make this process efficient, the dot shift in one layer relative to another must exceed the dot diameter.

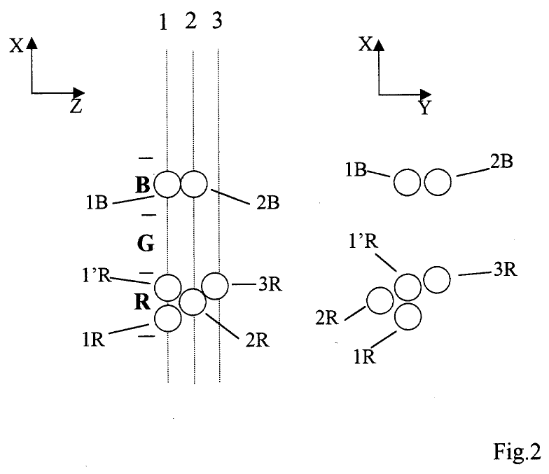

This procedure is illustrated in FIG. 2. Two image projections are shown. On the left side, three layers of the image, 1, 2 and 3, are indicated by vertical broken lines. The dots (circles) are distributed in these layers (in X and Z directions) and within RGB triad (along X direction) according to the color content of the image. In the case illustrated, the dots are located in Red and Blue sub-pixels. Since the Red sub-pixel contains the largest number of dots (1R, 1′R, 2R and 3R) the major component of the composed color of the RGB pixel in the scattered light will be Red. Right picture of FIG. 2 shows plane view of the image, normal to the light direction. The dots within each sub-pixel are distributed in such a way that all dots are equally exposed to the incoming light.

Thus, according to the present invention, there are certain important requirements for the placement of the dots within the image in the glass to provide color:

i. In the direction of color variation (i.e. X direction, according to the chosen in FIG. 1 orientation), the dots are placed in one or more color stripes of each RGB triad to reproduce the original color of the object, and this procedure is repeated along this direction with the fixed pitch of the RGB triad.

ii. In the perpendicular direction within the image plane (Y axis), the dots are placed in accordance with the image content.

iii. The dots within each plane layer are shifted in X and Y directions relative to the dots in other layers of the same color sub-pixel on the distance exceeding the dot diameter to provide equal light exposure for all the dots in the image.

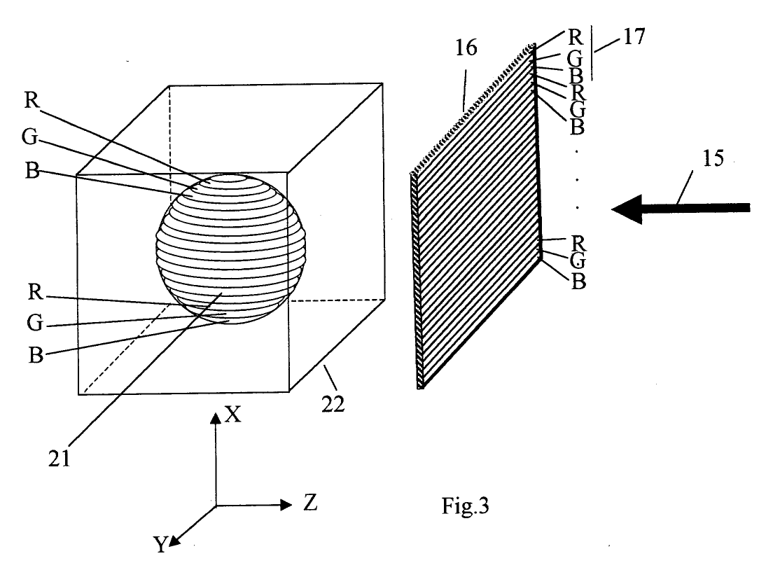

FIG. 3 illustrates the process of coloring a 3D image in the glass, the latter being shown as a sphere 21 inside of the glass cub 22. As in the 2D case, the color film 16 with multiple RGB triads 17 is attached to one of the cub sides, and a parallel beam of white light 15 is directed normal to the plane of this glass side. This results in slicing of the image volume into multiple flat sections having one of the three major colors. The dots are located on the image surface, i.e. on the outer rings of the slices. Within each slice, they will be colored with only one particular color. The positioning of the dots in the different color rings during their formation is predetermined by a computer program and can be appropriately chosen to introduce the original colors of the photo into the image in the glass.

Within each slice, the dots on the back side of each ring must be slightly shifted in Y direction relative to those on the front side to make all the dots in the slice equally exposed to the light beam.

All the above requirements for the dot placement made for the 2D images are applicable to the 3D images. The 3D images, however, impose more stringent requirements on the external light beam, since it must be parallel within the entire volume of the image.

While there have been shown and described the preferred embodiments of the invention, other modifications and versions of the invention will be apparent to those skilled in the art from the foregoing disclosure. For example, the color RGB stripes in the color film can be extended in the X direction and alternated along the Y axis, or, in another embodiment, the color film may be placed apart from the glass surface. Thus, while only certain embodiments of the invention have been specifically described herein, it will be apparent that numerous modifications may be made thereto without departing from the spirit and scope of the invention.

What is claimed is:

1. A method of coloring of two-dimensional images formed inside of glass, or any other transparent media, by visible dots produced with laser pulses, based on illuminating of said images with a parallel white light beam through a transparent color film composed of multiple stripes of Red, Green and Blue (RGB) filters, said multiple stripes of RGB filters are periodically repeated in one direction of said transparent color film and extended in perpendicular direction; said transparent color film is attached to the flat glass side in front of said parallel white fight beam to cover the entire image and thus subdivide the image plane into periodically repeating RGB color stripes; said dots composing said images inside the glass, are distributed within said periodically repeating RGB color stripes in a predetermined manner to form in the scattered light a color image.

2. The method of claim 1, wherein said transparent color film is placed on the glass side in front of the light beam and parallel to the two-dimensional image plane, while said parallel white light beam is directed normal to said two-dimensional image plane.

3. The method of claim 1, wherein the laser produced dots forming said two-dimensional images, are created in more than one layer to enhance artistic impression, said laser produced dots are distributed in all said layers in a predetermined manner to form a color image in the glass, said laser produced dots being distributed within all said layers in such a way that all said laser produced dots are equally and uniformly exposed to the light beam.

4. The method of claim 1, wherein the plane of the image in the glass is made in a close proximity to the glass surface, to which said transparent color film is attached.

5. The method of claim 1, wherein the multiple color levels are made by variation of the dot number or dot size in each said RGB color stripe, thereby varying the intensity of light scattered from each said RGB color stripe.

6. The method of claim 1, in which the period of said multiple stripes of RGB filters is made sufficiently short to allow for said image in glass to be perceived by a human eye as a color image.

7. The method of claim 1, wherein said period of said multiple stripes is made 0.3 mm wide, with said multiple stripes of RGB filters being 0.1 mm wide each.

8. The method of coloring of two-dimensional images formed inside of glass, or any other transparent media, by the dots produced with laser pulses, based on illuminating of said images with a parallel white light beam through a transparent color film composed of multiple stripes of RGB filters, said multiple stripes of RGB filters are periodically repeated in one direction of said transparent film and extended in perpendicular direction; said transparent color film is attached to the flat glass side in front of said parallel white light beam to cover the entire image and thus subdivide the image plane into periodically repeating RGB color stripes; said dots composing said images inside the glass, are distributed within said stripes of three different colors in a predetermined manner to form a color image in the transmitted light, along the light beam direction.

9. The method of coloring of three-dimensional images formed inside of glass, or any other transparent media, by visible dots produced with laser pulses, based on illuminating of said images with a parallel white light beam through a transparent color film composed of multiple stripes of Red, Green and Blue (RGB) filters, said multiple stripes of RGB filters are periodically repeated in one direction of said transparent color film and extended in perpendicular direction; said transparent color film is attached to the flat glass side in front of said parallel white light beam to cover the entire image and thus subdivide the image into periodically repeating RGB color slices; said dots composing said images inside the glass, are distributed within said periodically repeating RGB color slices in a predetermined manner to form in the scattered light a color image.

10. The method of coloring of the laser produced three-dimensional images of claim 9, wherein the laser produced dots are positioned only on the rings contouring each said color slice and placed in such a way that all said laser produced dots within each ring are equally exposed to said parallel white light beam.
